(19) United States
(12) Patent Application Publication
(10) Pub. No.: US 2008/0103039 A1
(43) Pub. Date: May 1, 2008

(54) Glass frit with iron selenide complex

(76) Inventor: James V. Jones, Fairview, TN (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/586,814

(22) Filed: Oct. 26, 2006

(51) Int. Cl. C03C 3/083; C03C 3/085; C03C 3/087

(52) U.S. Cl. 501/70; 501/68; 501/69

(57) ABSTRACT

A colored glass is provided that includes a base material and a colorant including Fe₂O₃ and Se. The Fe₂O₃ and Se are combined in the frit or glass as a Fe₂O₃—Se complex before being added with the base material.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates in general to a composition for automotive and architectural glass, and, more specifically, a method for retaining selenium with the composition during a glass fabrication process.

2. Background of Related Art

Window-type glass is manufactured mainly for automotive applications (e.g., windshields and backlights) and architectural applications (e.g., windows and doors of buildings and homes). Although many of the desired properties for automotive and architectural glass are very similar, the glass compositions typically used in each field of application have been quite different. For example, specific chemical elements and compounds are combined to create glass for improving the infrared absorption of glass products while maintaining a high level of visible transmission and to also have a good absorption in the ultraviolet portion of the spectrum.

Automotive glass must provide a very good transmittance of visible light while significantly blocking infrared light. These demands have typically been met using a tinted glass having a green coloration. However, a neutral glass color would be desirable to improve styling and avoid the glass color clashing with other portions of the vehicle. Glass for vehicle windshields is typically a laminate having two thin glass plies with a clear plastic interlayer. The glass for the remainder of the vehicle may be a single ply or it may have a similar configuration to the windshield.

Choosing an architectural glass for buildings puts more emphasis on the color of the glass and its physical/mechanical characteristics. Although clear glass is often used, it would be desirable in many cases to utilize a neutral grey color for its aesthetic and optical properties. Various coatings can also be applied to a grey glass in order to obtain other desirable spectral properties (i.e., colors). On the other hand, grey glass compositions already used in architectural applications provide insufficient visible transmittance to satisfy the requirements for an automotive glass. A typical grey architectural glass at 4 mm thickness may provide 55.5% transmittance using illuminant A (LTA) with a 40.5% ultraviolet transmittance, a 57% infrared transmittance, and a 57% total solar energy transmittance. Regulations require an automotive glass (except in trucks behind the B-pillar) to provide a 70% LTA.

The batch ingredients of a glass composition include some basic ingredients (e.g., sand, soda ash, limestone, dolomite, etc.) together with additives for determining various properties of the glass. One well known additive is iron. Iron oxide exists in two chemical forms in the glass, an oxidized form (Fe₂O₃) which is yellow and a reduced form (FeO) which is blue. Advantageously, the oxidized form of iron oxide absorbs a portion of the ultraviolet light passing through the glass product and the reduced form of iron oxide absorbs a portion of the infrared light passing through the glass product. In addition Fe₂O₃ with other coloring agents are used to provide various shades of green, blue, brown, and grey tints to the glass product. Often selenium is added as a colorant for producing such tints. Unfortunately, selenium is highly volatile at glass furnace processing temperatures. Typically, only 15% to 20% of the selenium is retained after processing the final glass product. Many methods have been used to counteract the volatility of selenium including the amount of selenium used, the size of the elemental selenium granules, or the use of reducing agents such as coal or silicon, or the use of oxidizing agents such as sodium nitrate or sodium sulfate. U.S. Pat. No. 2,955,948 teaches the use of oxidizers such potassium nitrate in order to try to retain as much of selenium as possible. U.S. Pat. No. 3,291,585 teaches the sintering of easily volatilizable chemicals with powdered glass as one method to reduce the volatility of materials which includes selenium. More recently, U.S. Pat. No. 6,672,108 teaches the use of Epsom salts to reduce the selenium evaporation. However, selenium is very costly and adding more selenium or other additional agents to the glass batch to compensate for the volatilization of the selenium can increase the cost of the final glass product. In addition, oxidizing agents such as sodium nitrate and sodium sulfate vaporize out of the glass batch as noxious gases.

A common practice in the glass industry is to return any unused glass that has been generated by the process back into the batch feed. The glass chemist has a taxing duty to calculate the selenium loss either as being generated from the batch component of selenium or a combination of the batch component of selenium and that of the cullet returned to the process.

U.S. Pat. No. 3,915,722 describes a method and compositions for making a series of easy to melt glass frits that contain a variety of colorants, but none employs selenium. This and other references fail to describe a low silica and high soda type batch that is easy to melt for making the host glass in the frit and that the desired colorants are more highly concentrated than the desired commercial glass product.

Therefore, there is a need in the glass industry to produce glass products that utilize selenium without having to incur the expense of providing additional selenium or other agents to the glass batch or frits for compensating or reducing volatilization of the selenium as it is processed in the glass making furnace.

### BRIEF SUMMARY OF THE INVENTION

The present invention includes an advantage of producing a colored glass containing selenium where a majority of the selenium is retained during the fabrication of the colored glass. A frit containing the Fe₂O₃—Se complex is mixed with the batch materials for producing the colored glass. The iron oxide and selenium as a complex reduces the mobility of the selenium within the glass structure which markedly reduces the tendency of the selenium to volatilize.

In one aspect of the present invention, an easy to melt colored glass is provided that includes base glass materials and colorants including Fe₂O₃ and Se. The Fe₂O₃ and Se are combined to form a Fe₂O₃—Se before being added with the base material during melting. The weight of the Fe₂O₃ must be at least 70% of the weight of Se added. The frit thus generated with the Fe₂O₃—Se complex can be added to a colorant forehearth or added as a portion of the mixture that is fed into the batch feeder of the furnace.

In yet another aspect of the present invention, a colored glass is provided for reducing a volatilization of Se within a glass batch when forming colored glass. A plurality of substances is supplied to a mixer for forming a glass batch. A Fe₂O₃ and Se are combined to form a Fe₂O₃—Se complex within the colorant for reducing the amount of Se volatized during a colored glass making process.

In yet another aspect of the present invention, a colored glass is provided that includes a base glass and a colorant. This glass is typically referred to as cullet as it was generated previously in the process. The composition of the cullet includes Fe₂O₃ and Se in a complex form. The Fe₂O₃ and Se form the Fe₂O₃—Se complex within the glass making process that reduces the amount of Se volatilized during a colored glass making process.

In yet another aspect of the present invention, a method is provided for reducing the volatilization of Se within a glass batch when forming colored glass. A plurality of substances is supplied to a mixer for forming a glass batch. The frit or cullet containing the Fe₂O₃—Se complex is supplied to the mixer to be added to the glass batch. The combined glass batch and the frit and cullet each with the Fe₂O₃—Se complex are heated for forming the colored glass. The Fe₂O₃—Se complex reduces the volatilization of Se during the processing of the colored glass.

In yet another aspect of the present invention, a method is provided for retaining selenium in colored glass during a processing from a glass batch raw material stage to the time of fabrication of the colored glass that includes mixing the glass batch with another glass that includes a Fe₂O₃—Se complex.

In yet another aspect of the present invention, the frit containing the Fe₂O₃—Se complex may be added to the molten glass in the colorant forehearth of container furnace and then blending into the molten glass by physically stirring the frit into the molten glass to homogenize the color.

Various objects and advantages of this invention will become apparent to those skilled in the art from the following detailed description of the preferred embodiment, when read in light of the accompanying drawings.

### DETAILED DESCRIPTION OF THE PREFERRED EMBODIMENT

Colored glass, used in the automotive and architectural industries made by a glass flow process is generally characterized by the following basic composition. An example of the components based on a weight percentage of the total glass composition is as follows:

TABLE I

| Base Glass | |
|---|---|
| Components | Weight % |
| SiO₂ | 68 to 75 |
| Na₂O | 10 to 18 |
| CaO | 5 to 15 |
| MgO | 0 to 10 |
| Al₂O₃ | 0 to 5 |

The above composition employs the base materials of glass wherein additionally, SO₃ is typically present in the amount of 0.03 to 0.30 wt. %, and more preferably, 0.15 to 0.25 wt. % in a final product. In addition, other components may be added to the batch glass as a colorant via a frit or cullet. Such components include iron oxide (Fe₂O₃), manganese compound, and cobalt or other colorants.

Iron oxide present in colored glass typically range in the quantities of 0.1 to 1.9 wt % Fe₂O₃. In prior art processes, this ingredient is added with the batch ingredients in the oxide form, i.e. Fe₂O₃. The iron oxide incorporated in the composition lowers both the ultraviolet and the infrared transmittance of the glass products. Iron oxide in the glass product generated by the process via normal commercial production has a redox ratio (defined as equal to the weight of FeO divided by the total iron as Fe₂O₃) in the range of about 0.18 to 0.26.

The addition of selenium (Se) moves the color of the glass towards bronze and cobalt moves the glass toward blue and each lowers the dominant wavelength and excitation purity. A desired neutral grey color is obtained by choosing relative amounts of selenium and/or cobalt oxide either through deliberate batch input or from the remnants of a previous product melted in the furnace, such as a cullet, used to make glass of the invention. Manganese dioxide is used to aid in maintaining the equilibrium of the iron since it acts as an oxidizer.

The glass of the invention is manufactured by a batch admixing of the components to feed a conventional SIEMENS float glass furnace. Sodium sulfate is mixed in the batch together with anthracite coal or graphite to accelerate the decomposition of the sulfate to act as a fining agent in the removal of bubbles or seeds. Manganese dioxide may be added in the batch to aid in the retention of the selenium. Typically, the batch components are mixed together in a single step and then metered into the furnace.

A manganese compound is present in an amount of 0 to 0.5 wt. % based on MnO₂ in the glass composition. This manganese compound can be added to the batch glass components in a variety forms, e.g., but not limited to MnO₂, Mn₃O4, MnO, MnCO₃, MnSO₄, MnF₂, or MnCl₂, etc.

Table II below discloses example amounts of raw material batch ingredients that are preferably used to form a grey glass composition.

TABLE II

| Batch Material | Range of Mass (lbs.) |
|---|---|
| Sand | 1000 |
| Soda Ash | 290 to 350 |
| Limestone | 70 to 90 |
| Dolomite | 215 to 280 |
| Salt cake | 2.5 to 11 |
| Rouge (97% Fe₂O₃) | 4.0 to 26.0 |
| Manganese Dioxide | 1.3 to 7.0 |
| Selenium | 0.04 to 0.65 |
| Cobalt Oxide | 0 to 0.055 |
| Anthracite coal | 0 to 2.5 |

When selenium is used as a colorant and is added to the glass base mixture as an element or a selenium frit, selenium has a low melting point (i.e., 400° F.) and vaporizes rapidly in the glass batch melt as the melt is subjected to high temperatures upward of approximately 2600° F. Frits are fused or partially fused materials that are added to the glass process in the forehearth of a container furnace as the molten glass is cooled. Frits are commonly used in making porcelains, glazes, and enamels. Frits are commonly added to a batch glass material during the cooling stage for forming a desired design or surfacing agent on final glass structure. A selenium frit is produced by melting the selenium with other base materials or colorant for forming a colorant mixture when added to the base glass batch mixture. The selenium frit is added during the cooling stage (e.g., 2000° F.) in an attempt to reduce the volatilization of the selenium. The selenium frit is quickly melted from its glass form in an attempt to reduce volatilization of the selenium; however, the percentage of selenium retained in the final glass product in comparison to the selenium retained in a final glass product produced by adding the selenium in its element form is only slightly higher. Additional selenium or additional oxidizing agents may be added to the batch or selenium frit to reduce volatilization and achieve the desired color that is demanded, but a disadvantage is the added cost of the oxidizing reducing agent or the cost of addition selenium which is expensive.

Trial melts were made in the laboratory to investigate the retention of selenium when selenium is add to the glass batch in its element form and when the selenium is added to the glass batch in a selenium frit. Batches were weighed, placed into a glass jar about 2″ high and 2″ inside diameter, and dry mixed for 10 minutes each on a Turbula mixer. The dry batch was placed into an 80% platinum/20% rhodium crucible that stands 2″ tall and has an inside diameter at the top of 2.5″ and is tapered to the base which has an inside diameter of 1.75″. An amount of 4.5 ml. of water is added to the dry batch in the crucible and mixed with a metal spoon. After such preparation, a group of different batches is melted in a gas/air fired furnace at the same time for 1 hour at 2600° F. and each crucible is removed in turn from the furnace and fritted. Fritting the glass involves coating the inside of the platinum/rhodium crucible by rolling the molten glass around the inside of the crucible and then plunging the crucible into cold water. After removing the crucible from the water and draining, the broken glass particles are removed from the sides of the crucible and mechanically mixed inside the crucible. All samples are fritted in like manner and all crucibles are placed back into the furnace for another hour interval at 2600° F. and the fritting procedure is repeated. After the second fritting process, the crucibles are returned to the furnace for 4 hours at 2600° F. Each crucible is removed in turn from the furnace and each molten glass sample is poured into a graphite mold with an inside diameter of 2.5″. Each glass is cooled slowly, labeled, and placed into an annealing furnace where the temperature is quickly raised to 1050° F., held for 2 hours, and then slowly cooled by shutting off the furnace and removing the samples after 14 or more hours. The samples are ground and polished to about 4.0 mm. thickness and subsequently the spectral properties are measured for each sample.

The following table includes the actual weight of the elements used and/or the weight percentages utilized in the experiments. In each of the cases where selenium was added to the batch in its element form or was added as a selenium frit, the result was a lack of retention of selenium during a processing from a glass batch raw material stage to the time of fabrication of the colored glass. This group of experiments shows that when the frit is composed of selenium without iron oxide necessary to form the Fe₂O₃—Se complex the volatility of selenium is only modestly improved in Series F. The Brickox batch material is the trade name for a batch material containing 78% MnO₂ together with other glass compatible materials. Brickox is the trade name used by Prince Manufacturing Company for the mineral pyrolusite.

TABLE III

| | Series Melt | | | | | |
|---|---|---|---|---|---|---|
| | A | B | C | D | E | F |
| SE FRIT | — | — | — | 1.3227 | 1.0583 | 0.8824 |
| SE (element) | 0.0176 | 0.0164 | 0.0134 | — | — | — |
| ppm Se in batch | 126.5 | 117.9 | 96.3 | 94.2 | 75.5 | 63.0 |
| CO3O4 | 0.0053 | 0.0054 | 0.0053 | 0.0054 | 0.0052 | 0.0054 |
| BRICKOX 6807 | 0.264 | 0.2635 | 0.264 | 0.264 | 0.2636 | 0.2644 |
| NA2SO4 | 0.7807 | 0.7806 | 0.78 | 0.7803 | 0.7802 | 0.78 |
| ROUGE | 0.4785 | 0.4794 | 0.4792 | 0.4828 | 0.482 | 0.4817 |
| WT. % FEO | 0.050 | 0.051 | 0.053 | 0.051 | 0.053 | 0.058 |
| WT. % FE2O3 | 0.373 | 0.373 | 0.373 | 0.373 | 0.373 | 0.373 |
| WT. % MNO2 | 0.149 | 0.149 | 0.149 | 0.149 | 0.149 | 0.149 |
| PPM CO | 28.0 | 28.6 | 28.0 | 28.3 | 27.3 | 28.4 |
| REDOX FEO/FE2O3 | 0.134 | 0.137 | 0.142 | 0.137 | 0.142 | 0.156 |
| est. PPM SE Retained | 26 | 24 | 19 | 17 | 14 | 18 |
| est. % Se Retained | 20.6% | 20.4% | 19.7% | 18.1% | 18.5% | 28.6% |

To reduce the vaporization of the selenium and to retain selenium within the glass batch during processing, the selenium is added to the glass batch in a frit that contains the Fe₂O₃—Se complex. The complex is similar to the amber chromophore, iron sulfide, which can be termed as a chemical grouping that absorbs light at a peak of 480 nanometers for generating a brown color in the glass. The Fe₂O₃—Se complex exists with the glass network structure. The grouping of the selenium and iron oxide as a complex reduces the volatilization of the selenium and raises its vaporization temperatures. The selenium within the glass batch when added as Fe₂O₃—Se complex bonds to the iron and replaces the oxygen within parts of the glass network. The chemical bond between the selenium and the iron makes the selenium resistant to volatilization since the selenium is not free to move about in the glass network. Less than 25% of selenium is vaporized in the final glass product after fabrication.

The Fe₂O₃—Se complex is produced as a frit by melting the iron and selenium together in combination with other glass components such as sand, limestone and dolomite. The frit is cooled and then added to the glass batch and then fed to a glass furnace such as the float furnace at the batch feeder.

Preferably, the Fe₂O₃—Se complex is formed in a cold top melter furnace (not shown) to reduce volatilization of the selenium as it is formed into the Fe₂O₃—Se complex. In such a configuration, a glass melting furnace includes a melting chamber containing a body of molten glass. A heating element, such as electrodes in the side walls or bottom wall, is provided to heat the molten glass. An opening is provided to deposit solid state colorant material in its raw form to the completely cover the top of the body of the molten glass. The batch material is continuously melted from the lower layers of the molten glass while the upper layers retain a substantially solid form. Fresh solid state colorant material is continuously supplied to the top layer of the body of molten glass to maintain the entire layer of batch material to a desired depth. Molten glass colorant is continuously withdrawn from the lower layers while fresh solid state colorant material is intermittently added to the top layer in the cold top melter furnace. The adding of the solid state colorant material assists in retaining vaporized selenium. That is, as the selenium within lower layers of the molten glass is heated and vaporized, the solid state colorant material on the top surface covers the top of the molten glass thereby forming a vapor barrier and reducing volatility of the selenium by preventing a substantial portion of the vaporized selenium from escaping the through the top layer. The Fe₂O₃—Se complex is cooled to form a solid state frit. Alternatively, other methods may be used to produce the Fe₂O₃—Se complex. It should be noted that the Fe₂O₃—Se complex may be added as to the glass batch as a cullet.

As a result, selenium is retained without adding additional selenium or other additional agents required for the sole purpose of reducing the volatilization of the selenium. The iron oxide which is an existing compound that is currently used in the batch to produce the desired color to the glass product is mixed with the selenium as a frit for forming the complex. Since a frit may be used to add coloring agents to the glass batch (i.e., when a colorant forehearth is not utilized), expense for additional materials or processing steps are avoided. For example, a grey cullet containing the Fe₂O₃—Se complex could be used as a component of a batch mixture that is making a bronze color that also uses selenium to create the bronze color. A glass chemist will adjust the batch chemistry to reflect the different concentrations of colorants required to make the desired product.

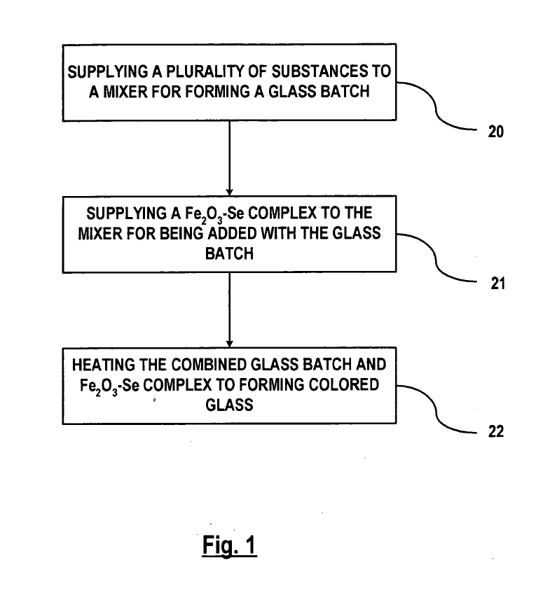

FIG. 1 is a flowchart for a method for producing a colored glass that contains selenium. In step 20, a plurality of substances is supplied to a mixer for forming glass batch. The plurality of substances includes the base materials for forming glass. In addition, colorant materials may also be added in step 20. In step 21, a Fe₂O₃—Se complex is supplied to the mixer for adding the Fe₂O₃—Se complex to the glass batch. In step 22, the mixed glass batch and Fe₂O₃—Se complex is supplied to a furnace and heated for forming a colored glass. The Fe₂O₃—Se complex reduces the volatilization of the selenium during the fabrication of the colored glass. MnO₂ may be added to either the glass batch or as part of the Fe₂O₃—Se complex for use as an oxidizing agent for reducing the volatilization of the selenium as it is heated for producing the colored glass.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A colored glass comprising:
a base material; and
a colorant including Fe₂O₃ and Se;
wherein the Fe₂O₃ and Se are combined as a Fe₂O₃—Se complex before being added with the base material.

2. A colored glass having a base and a colorant, wherein the composition of the colorant comprises:
Fe₂O₃; and
Se;
wherein Fe₂O₃ and Se are combined to form a Fe₂O₃—Se complex within the colorant for reducing the amount of Se volatilized during a colored glass making process.

3. The colored glass of claim 2 wherein a weight of the Fe₂O₃ is at least 70% of a weight of Se added.

4. A method of reducing a volatilization of Se within a glass batch when forming colored glass, the method comprising the steps of:
supplying a plurality of substances to a mixer for forming a glass batch;
supplying a Fe₂O₃—Se complex to the mixer to be added to the glass batch; and
heating the combined glass batch and the Fe₂O₃—Se complex for forming the colored glass, the Fe₂O₃—Se complex reducing volatilization of Se during the processing of the colored glass.

5. The method of claim 4 further comprising the step of supplying MnO₂ to the glass batch for reducing volatilization of Se during the processing of the colored glass.

6. The method of claim 4 wherein the Fe₂O₃—Se complex is added to the glass batch as part of a colorant.

7. The method of claim 6 wherein the colorant including the Fe₂O₃—Se complex is added to the glass batch in a colorant forehearth.

8. The method of claim 7 wherein the colorant including the Fe₂O₃—Se complex is blended with the glass batch by stirring the colorant including the Fe₂O₃—Se complex into the glass batch to homogenize the color.

9. The method of claim 4 further wherein MnO₂ is added to the glass batch as part of the plurality of substances.

10. The method of claim 4 wherein the Fe₂O₃—Se complex is provided into a batch feeder of the furnace for mixing the Fe₂O₃—Se complex and the glass batch.

11. The method of claim 4 wherein at least a portion of the Fe₂O₃—Se complex is added to the mixer as a cullet.

12. A method of retaining selenium in colored glass during a processing from a glass batch raw material stage to the time of fabrication of the colored glass which comprises mixing the glass batch with a colorant that includes a Fe₂O₃—Se complex.
